(19) United States
(12) Patent Application Publication
(10) Pub. No.: US 2012/0278095 A1
(43) Pub. Date: Nov. 1, 2012

(54) SYSTEM AND METHOD FOR CREATING AND MANAGING THERAPEUTIC TREATMENT PROTOCOLS WITHIN TRUSTED HEALTH-USER COMMUNITIES

(75) Inventors: Joydip Homchowdhury, Round Rock, TX (US); Kimberlie Louise Cerrone, San Francisco, CA (US)

(73) Assignee: TIATROS INC., San Francisco, CA (US)

(21) Appl. No.: 13/450,138

(22) Filed: Apr. 18, 2012

Related U.S. Application Data
(63) Continuation-in-part of application No. 13/096,887, filed on Apr. 28, 2011.

(51) Int. Cl. G06Q 50/22

(52) U.S. Cl. 705/2

(57) ABSTRACT

Systems and methods of creating, managing and accessing treatment plans for patients having a condition are disclosed herein. Patients have CarePods created for the treatment of their condition and their doctors and other caregiver relevant to their treatment. In one embodiment, treatment plans may be constructed by a plurality of modules that may input data and metadata regarding the condition, the treatment, potential medications, potential medical monitoring equipment. Such treatment plans may be employed as a template for other CarePods and other patients. In other embodiments, data from the treatment may be collected to inform caregivers the response of the patient to treatment. In addition, data from the treatment of a condition may be aggregated from a plurality of patients being treated for a condition. This aggregated data may be used to deduce the efficacy of a particular treatment to a condition.

### CROSS-REFERENCE TO RELATED APPLICATIONS

This Patent Application is a Continuation-in-Part (CIP) Application, and claims the benefit of, a co-pending Application with a Ser. No. 13/096,887 filed by common Inventors of this Application on Apr. 28, 2011. The disclosure made in the application Ser. No. 13/096,887 is hereby incorporated by reference in its entirety.

### BACKGROUND

Doctors currently create and administer treatment plans for patients for a wide variety of conditions. Oftentimes, patients may not be clear on instructions for taking medications or the need for follow-up and informing doctor's regarding reactions to the treatment or providing information regarding their medical condition or changes thereto.

### SUMMARY OF THE INVENTION

Several embodiments of the present invention comprise systems and methods of creating, managing and accessing treatment plans for patients having a condition are disclosed herein. Patients have CarePods created for the treatment of their condition and their doctors and other caregiver relevant to their treatment.

In one embodiment, treatment plans may be constructed by a plurality of modules that may input data and metadata regarding the condition, the treatment, potential medications, and potential medical monitoring equipment. Such treatment plans may be employed as a template for other CarePods and other patients. In other embodiments, data from the treatment may be collected to inform caregivers the response of the patient to treatment. In addition, data from the treatment of a condition may be aggregated from a plurality of patients being treated for a condition. This aggregated data may be used to deduce the efficacy of a particular treatment to a condition.

Other features and advantages of the present system are presented below in the Detailed Description when read in connection with the drawings presented within this application.

### BRIEF DESCRIPTION OF THE DRAWINGS

FIG. 1 shows a high level block diagram of a possible set of trusted users and possible modules for a system built in accordance with the principles of the present invention, and more particularly for medical applications built upon the system.

FIG. 2 depicts the concept of a social pod as made in accordance with several of the present embodiments.

FIG. 3 shows a flow chart of one embodiment of creating and authenticating a social pod within the context of a medical application.

FIG. 4 is a high level block diagram of a system architecture built according to the principles of the present application.

FIG. 5 shows a flow chart of one embodiment of a multimedia content engine as made in accordance with several of the present system embodiments.

FIG. 6 is one embodiment of a present system as built and hosted using existing network infrastructure.

FIGS. 7A and 7B show one embodiment of a present system as built for the treatment of PTSD for returning military veterans.

FIGS. 8A and 8B show one embodiment of a de-identifier module to de-link information within communications of the social pod that contains certain data that might identify patients receiving treatment.

FIG. 9 depicts one embodiment of a screen shot showing the functionality of a treatment plan set up for a patient by a physician.

FIG. 10 shows one embodiment of a program funding module that enables administrators of a social pod to raise funds for programs via the present system.

FIG. 11 depicts one embodiment of a module for the creation of a template to capture data from a medical instrument that may be used in the monitoring of treatment.

FIG. 12 is one embodiment of a system and/or method for creating a treatment plan for a patient having a condition.

FIG. 13 is one embodiment of a system and/or method of setting reminders to patients and caregivers during the course of a treatment.

FIG. 14 is one embodiment of a system and/or module for the capturing of data of a medical instrument monitoring the efficacy of a treatment of a condition.

### DETAILED DESCRIPTION

### Various Embodiments of CarePods

As hospitals and other HCPs promulgated internal regulations in response to the requirements of laws and regulations of HIPAA, one embodiment of the present invention helps HCPs comply with their internal regulations by providing for a networked system and method of managing the communications among a number of “trusted” users—e.g. by and between a physician and a patient.

In one embodiment, the present system comprises a versatile cloud computing software platform where doctors and researchers may use contemporary social networking tools to communicate with patients and the extended care team online, on tablets and via mobile phones, sharing personal health information and medical records within a HIPAA privacy and security compliant environment. The present system may be constructed as a rule-based computing system that insures that all trusted users and their interactions are compliant to federal, state and their own non-governmental (e.g. university, corporate or the like) privacy and security requirements. The present system should also be flexible to allow users (i.e. HCPs, issue groups or the like) to create specific on-line communities to address particular conditions, diseases or other health-related conditions or issues.

In another aspect of the flexibility, one embodiment of the present system should be to have the system available to users online, on tablets, and on mobile phones. This may be desirable in order to ‘cross the digital divide’ that separates low-income user/patients who do not have high-speed Internet access from health care and support services from which they may otherwise be excluded.

In one aspect, it is desirable to construct the present system in a versatile manner. For example, the present system may be used to construct and support many different types of specific-purpose online communities. The present system may incorporate one or many different types of social networking tools, including audio and video blogging and video chats, and other known types of synchronous and asynchronous communications. As literally hundreds of millions of Facebook, LinkedIn and Twitter users already know how to use social networking technology, the present system incorporates a suite of easy-to-use social networking functions, including audio and video blogging, text messaging and video chats, within a HIPAA-compliant online platform. This, in turn, greatly expanding the ability to connect clinical services to patients (and research studies to research subjects) in novel ways, remotely, cost-effectively, synchronously and asynchronously.

In addition, it is desirable that the present system incorporate content files into such communications—e.g. audio, video, medical application and any other commonly used documents or applications. The present system handles content files of any size, and content files that are created in virtually any underlying application, including the commonly used document, audio, video and specialized medical applications. It may be desirable for the present system to accurately preserve the fidelity of such files and records. The ability to use and share information and medical records within specific purpose communities creates the opportunity to develop new and efficient ways of using it.

In addition to the features listed above, it may also be desirable that the present system include other contemporary technologies to improve the user experience. For example, the use of avatars and other gaming technologies may increase the appeal of programs for some users, while other technologies may improve the user experience for veterans who are blind or hearing impaired.

### Trusted Communities and/or Social Pods

In one possible aspect, the present embodiment may require that the physician communicate with a patient who is authenticated at the time of communication to the patient. In addition, the system stores and/or otherwise archives the interaction between the physician and the patient to form a part of the latter's EHR.

In another possible aspect, the present system may define a set of “trusted” users of the network. Such trusted users may need to be authenticated to establish their level of engagement and interaction with the system. Such authentication may be accomplished by any known method, manner or system for such authentication. Examples include password protection, challenge-response interactions, biometrics or the like.

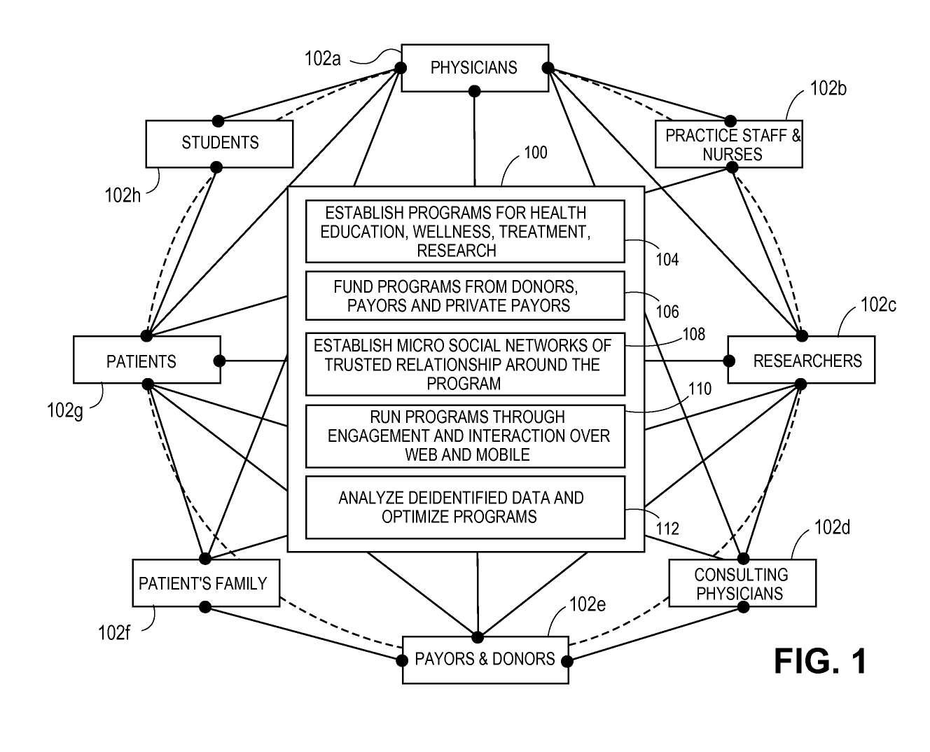

FIG. 1 describes a set of entities that might comprise a prototypical environment of trusted users. Users (collectively labeled 102) are shown interconnectedly with the present system 100 and, possibly, connected amongst themselves apart from system 100. A set of users might comprise the following types of individuals: physicians 102a, practice staff and nurses 102b, researchers 102c, consulting physicians 102d, payor and donors 102e, patient's friends and family members 102f, patients 102g and students 102h.

Each of the users 102 represent entities that may have known communication and computing devices (not shown) in order to affect a networked environment. For example, users 102 may variously have smart phones, cell phones, computers, tablets and the like that may be configured to run a secure, encrypted software environment, as might be presented in a browser or in any other known interfaces. It will be appreciated that the present system encompasses the use of all known devices and means of networked communication that would facilitate the present system as described herein.

The present system may also allow for easy dynamic management of the social pod. For example, the present system may allow for the addition and/or deletion of members in a seamless manner. To appreciate the flexibility of communities that the present system could enable, trusted communities might comprise one, two, or any number of members depending on their specific purpose. For mere exemplary purposes, communities may consist of:
a single member using a self-directed therapeutic intervention
doctor+doctor
doctor to pharmacy
doctor to health insurance agent, e.g., for utilization review
doctor+patient
doctor+patient+family
doctor+entire care team
patient+entire care team
doctor+multiple patients or multiple families
research team
research team+participants
wellness program enrollees
medical-educational program enrollees

The identity of every participant in a community may be authenticated using one or more conventional identity authentication methods each time the member signs on to the community or accesses a content file. The present system may incorporate a variety of conventional authentication methods; the specific method(s) used to authenticate the members of a given community may vary as appropriate to its specific purpose.

Communities may be moderated, or self-directed. One or more moderators may oversee some types of programs, being able, for example, to add new members, remove objectionable content, and update content files. Other types of programs may be completely unsupervised and self-directed.

Because the present system may ensure HIPAA privacy and security compliance, communications and medical records that contain personal health information may be shared among members of the community, synchronously and asynchronously, online and on tablets and mobile phones.

In addition to setting up and populating trusted communities, the present system may use a number of technical strategies to pre-set and enforce access rights to ensure the privacy of communications, and appropriately limit access to certain files. Easy-to-use and redundant methods assure that the moderator(s) exercise complete and dynamic control over which communications and medical records, or parts thereof, are available to everyone, and which are available only to a certain subset of the community.

System 100 may comprise a set of networked computers and/or processors—in communications possibly with computers, processors or mobile devices that are in the possession or under the control of the users 102. There are many desirable and optional features that system 100 provides to users 102 and to the various HCP that are connected to the users.

For example, system 100 may provide the following:
(1) establish networked infrastructure for programs for health, education, prevention, wellness, treatment and/or research (104);
(2) enable automated and/or distributed funding of programs from donors, granting organizations, payors and private payors (106);
(3) establish micro social networks of trusted relationships around the program;
(4) run programs through engagement and interactions over networks (e.g. intranets, the internet or the like) and mobile devices; and
(5) analyze de-identified data that flows through system 100 and optimize programs that are made in accordance with the present system (112).

One embodiment of analysis and optimization of the present system provides that the interactions of involving users and the present system provides a feedback mechanism to sharpen and improve the effectiveness of the system for treating or servicing its users. For example, one embodiment of the present system might be a Clinical Care and Education program that allows providers several means to capture the data about the effectiveness of their programs. The “social” interactions inherent in the solution may be captured by the system, for example as unstructured data. The built Query-Response service allows the system to get explicit feedback in a secure fashion. In addition, the Therapeutics module might allow the system to capture responses from their patients and participants e.g. level of pain, mood, etc., along with compliance data such as “Did you take all three dosages of the medicine, on time” etc. This data set allows the system and its designers (which could be the clinicians and researchers of the program itself) to look for correlation among a particular protocol and its effectiveness and make changes to their programs, be it therapeutics or course material, style of presentation, etc.

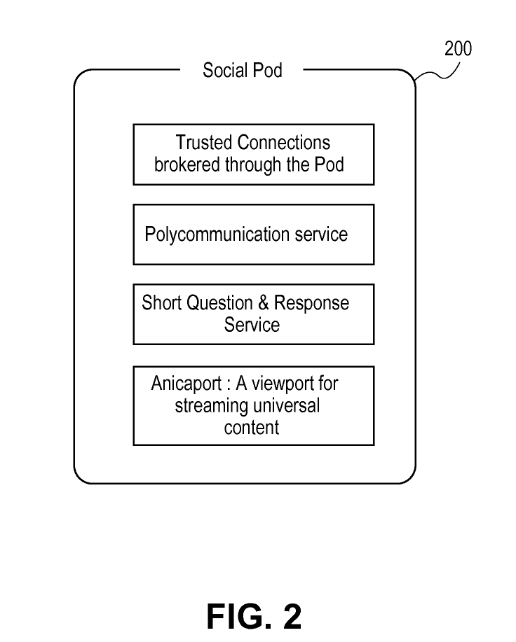

System 100 may be employed to create a networked “microcommunity” of users—a construct called a “social pod”. FIG. 2 depicts a social pod 200. Social pod 200 is enabled or otherwise hosted by system 100 as a set of interconnected computers, processors, mobile devices or the like. Desirable features of social pod 200 may include: a set of trusted connections brokered through the system; a polycommunication service (e.g. email, SMS, voicemail or the like); short question and response service; and a viewport and/or an application (called an “anicaport” for purposes of this application, as described below). This anicaport may act, at a high level, as a viewport for downloading, uploading, and/or streaming of content. Such content may be placed into appropriate formatting and made available to all or a subset of trusted users, possibly in some universal format. In one embodiment, a social pod may provide a restricted and secure way for a micro community of people organized around a specific outcome (e.g. clinical research, treatment of a medical condition, education for wellness etc.) to interact, collaborate, capture structured data, etc.

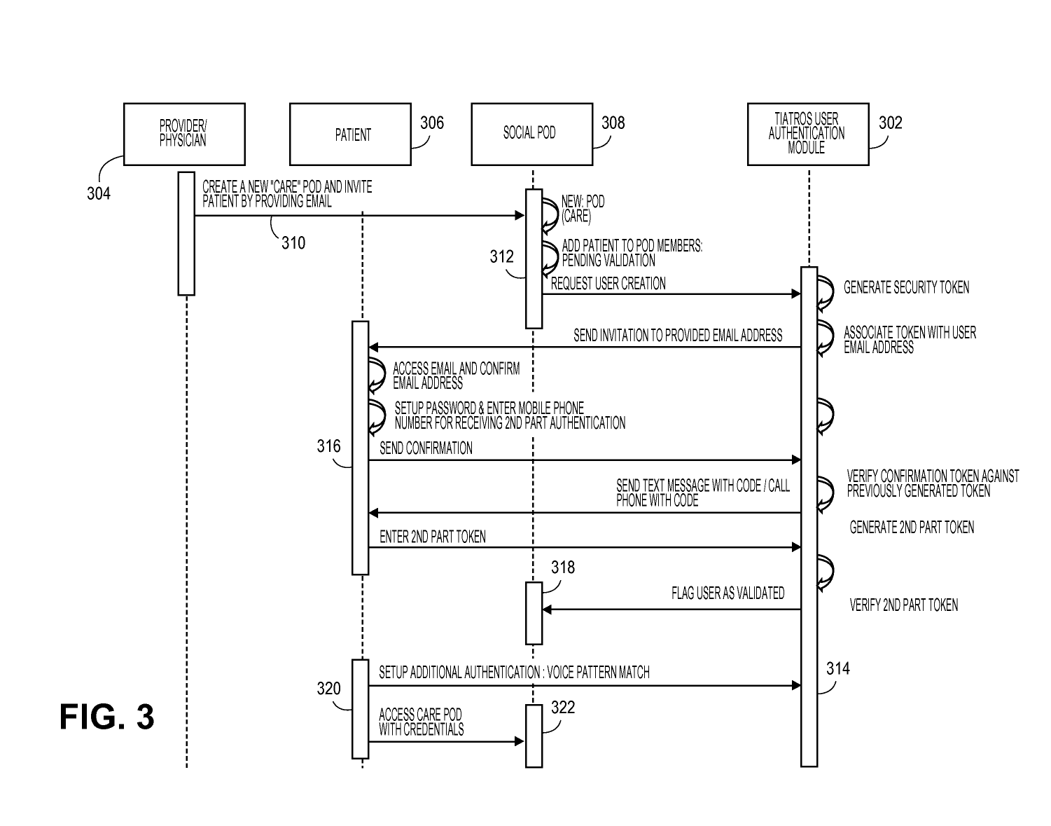

FIG. 3 depicts one embodiment of a method of creating a social pod. In this embodiment, the system may allow for a multi-part authentication procedure and mechanism. It will be appreciated, however, other mechanisms—with varying levels of authentication—may be set up and managed. It will be appreciated that the following description is merely by way of example and that other mechanisms and methods may be employed to created trusted communities and/or social pods.

Social pod 308 may be created by a provider, a physician or researcher 304 via the present system. Provider 304 alerts the system that a new “Care” pod is to be created and provider 304 may populate the pod by listing individuals (e.g. patient 306) and have the system invite patient 306 via some identified means of communication (e.g. by providing the patient's email address to the system) at 310. The system may manage social pod 308 as a set of data structures and/or routines to affect its creation and dynamic management. At 312, the system (via social pod 308 or the like) creates the new “Care” pod and adds patient 306 as a pod member, pending authentication. Pod 308 may then request the system to create patient as a User—in this example, via a request to the system's authentication module 302.

Authentication module 302 may perform such actions as shown at 314. To wit, module 302 may generate a security token and associate the token with the user's email address or any other identifier. Module 302 may return an invitation to the identified email address of the putative new user/patient 306. Patient 306 may then (at 316) access her email and confirm the address, setup a user password and enter other means of communication for the system (such as mobile phone number or the like). This other means of communication may be used to receive a second part authentication for the user. Once initial confirmation is received from patient 306, module 302 may confirm the token against the previously generated token (at 314) and send a text message to the mobile phone (or call the phone directly) with a second part token. Patient 306 may enter the second part token and return to module 302 for further authentication. If module 302 confirms the second part token, module 302 may signal to pod 308 that there is a trusted individual/user at 318.

Additional authentication means may optionally be set up, as desired. For example patient 306 may set up a voice recognition match for further authentication at 320, back to module 302. As time goes forward, patient 308 is then considered a trusted user and may access the pod with suitable credentials at 322.

In one embodiment, the present system may provide flexibility in setting up trusted relationships. For this, it may be desirable to establish that the forms of identifications provided by the user are indeed accessible by the user. For this, the present system may establish such multi-part authentication mechanism as desired. In addition, the administrators or providers of the system can choose the levels of authentication required for trusted users, with a basic minimum possibly designed.

### System Architecture

Having described one aspect of the present system—i.e. the notion of trusted users and the social pod, one or more suitable architecture embodiments for the construction of the present system will now be described. In addition, it will be shown how one embodiment of the present system may leverage existing internet and other infrastructures for efficient build-out of the present system.

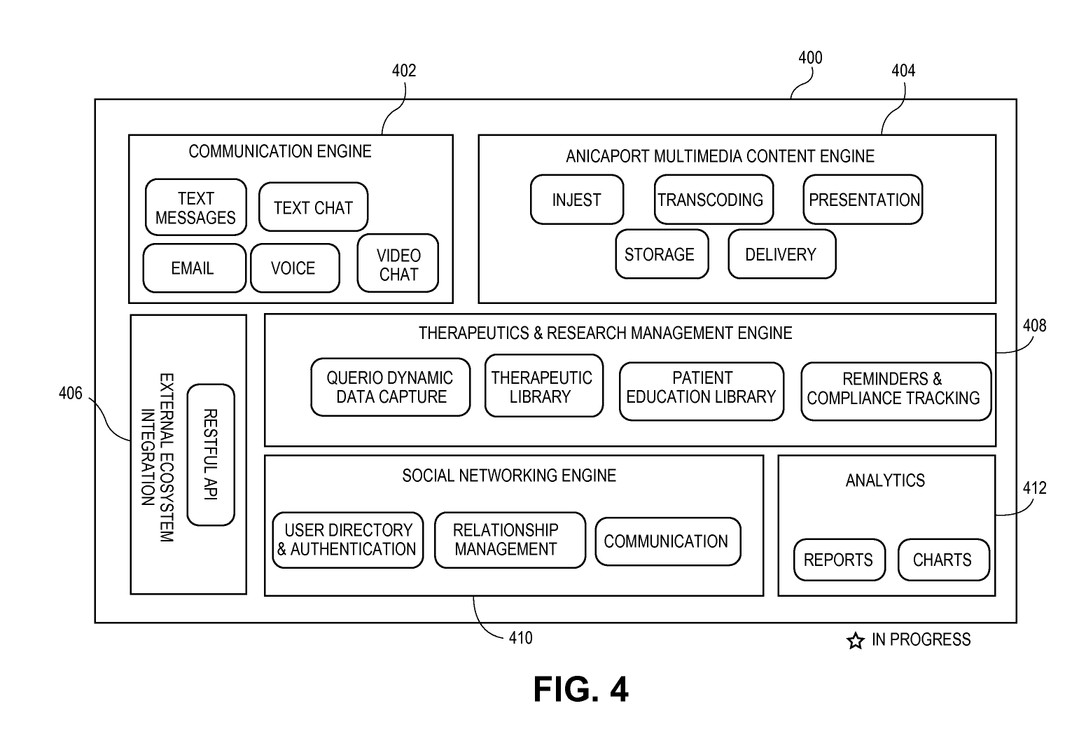

FIG. 4 depicts one embodiment of an architecture of a system that may perform in accordance with the teachings of the present invention. System 400 may advantageously comprise multiple modules for the creation and dynamic operation of the present system. Such modules may comprise the following: communication engine 402, multimedia content engine 404, external ecosystem integration module 406, therapeutic and research management engine 408, social networking engine 410 and analytic engine 412. Each module/engine will be discussed in turn below.

Communication engine 402 is the part of system 400 that comprises sufficient hardware and logic to setup and dynamically manage the flow of communications between trusted users of the present system. Communication engine 402 may manage communications from disparate means and modes of communications—e.g. text messages, chat, email, voice, video chat and the like.

Multimedia content engine 404 is that part of the system 400 that comprises sufficient hardware and logic to create, store, disseminate and dynamically manage the flow of data in and out of system 400 by and to trusted users of the system. Submodules of engine 404 might advantageously comprise: injest submodule, transcoding submodule, presentation submodule, storage, and delivery submodules.

External ecosystem integration engine 406 may present a set of RESTful API, that allows it to exchange its data with third party systems and using (when applicable) industry standards such as HL7 etc. These API's will allow external systems to send information to the present system, e.g. a medical device or EHR system.

Therapeutics and Research Management Engine 408 is that part of the system 400 that comprises sufficient hardware and logic to create, store, disseminate, and dynamically manage treatment plans and pathways for trusted users on the system. It may be desirable for each trusted user of the system that is actively being treated via system 400 to be tracked by engine 408 and their progress logged and processed. Submodules of engine 408 may advantageously comprise: querio dynamic data capture submodule, therapeutic library, patient education library, and reminders and compliance tracking submodule.

Social networking engine 410 is that part of system 400 that comprises sufficient hardware and logic to dynamically manage the various communications and relationships between trusted users of system 400. It should be appreciated that any known combination of processors, data structures, storage and communication media—including transport of data across networks, intranets, the internet—may be utilized to affect the implementation of the present system, as is known to one skilled in the art.

One aspect of the present system is the ability to transcode, store, deliver and present content of a variety of media types. This would be desirable in any number of applications and context—and one such application is in the field of healthcare where patients may thrive better in a treatment program where use of multiple means of communications and messaging (both synchronous and/or asynchronous) may be applied. For example, a patient may not feel like talking directly to a doctor, or writing a lengthy email about conditions and results; but the patient might be amenable to uploading an audio or video file describing such. So, users and applications can use a multimedia content server/network—such as “anicaport” to affect solutions.

It may also be desirable to create an anicaport in such a way as to build solutions that may have shared content; but it is not desired to transmit the files multiple times. With Anicaport, content files of practically any size can be shared. The content files that are authored in native formats may be uploaded and shared, anicaport may transcodes them to ensure that files will display in Web browser or Mobile device without the need for additional software. In addition, content files may be streamed and transmitted over secure, encrypted protocols and designed to be accessible from anywhere on the globe.

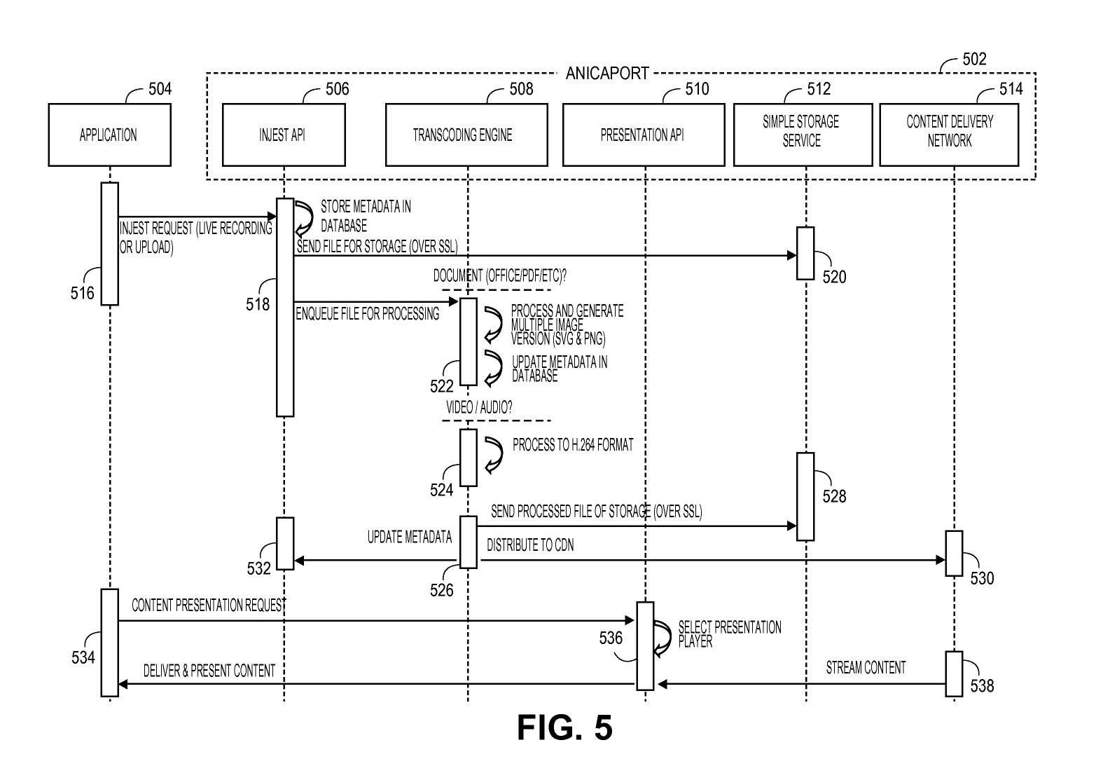

FIG. 5 shows one flow chart of the multimedia content engine (“anicaport”) in dynamic operation. Anicaport 502, in this embodiment, comprises injest API 506, transcoding engine 508, presentation API 510, storage 512, and content delivery network 514. Some application (under user control or otherwise) 504 may make an injest request at 516—e.g. a live recording or upload or the like. Injest API 506 may, at 518, store any metadata (if any) in storage or database and send the file associated with the request to storage 520.

This file or data may be queued for further processing at 522 and/or 524, if needed. If the file or data is a form of a document (e.g. office, pdf, etc.), then transcoding engine 508 may process and generate one or more versions, perhaps in different formats, such as image format (e.g. SVG & PNG). Any metadata associated with the transcoding, if any, may be updated in a database or storage. If the file or the data is either an audio or video file, then transcoding engine 508 may process it to a different format—e.g. H.264. Any metadata generated there may also be stored as noted.

At 526, transcoding engine 508 may then send the processed data/file to storage (perhaps over SSL) at 528. In addition, the data/file may be distributed to content delivery network at 530. If there is any update that is needed to earlier saved metadata, it may be accomplished at 532.

Over time, the same or different application 504 may make a request for a presentation of stored content (to which the user or owner of the application has rights to) at 534. Such request may be made to a presentation API 510, which then may select a presentation player at 536 and initiated streaming content at 538 from content delivery network at 538. Presentation API may then oversee such streaming data to application at 534. All of this may be accomplished with the anicaport or other parts of the system checking and enforcing authorizations and permissions—matching users/applications to content.

One embodiment of code that implements an anicaport is shown immediately below. It will be appreciated that many different implementations are possible and are contemplated within the scope of the present invention.

### System Infrastructure

While the architecture of the present system presents one embodiment for the various modules that may be desirable in such a system, the present system itself may be hosted in a myriad of ways, to include leveraging existing infrastructures and the different companies that may provide services and hardware for such hosting and infrastructure.

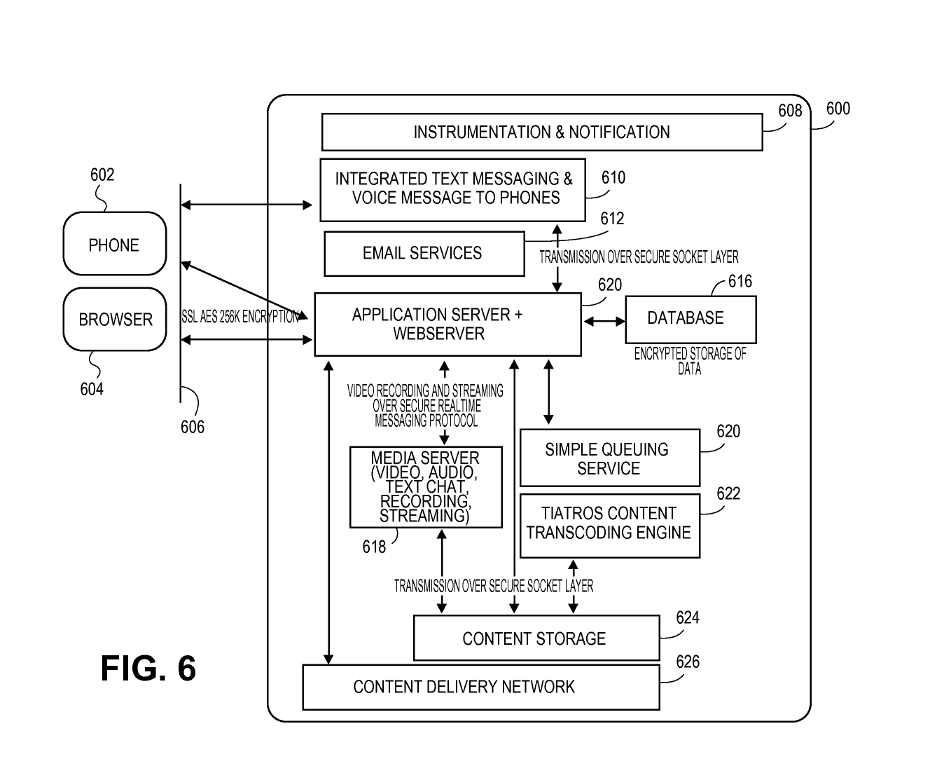

FIG. 6 depicts one embodiment of the present system (600) as it may be hosted over existing infrastructure. Users of the present system may connect by a myriad of communication pathways. For example, users may connect via phone (602), mobile or otherwise, and by a browser 604 through standard interfaces 606. Once connected to the present system 600, the various modules of the present system may be a set of separately hosted modules that are in communication with one another.

The embodiment depicted in FIG. 6 has modules—instrumentation and notification module 608, integrated text and/or voice messaging 610, email service 612, application server and webserver 614, database 616, media server 618, simple queuing service 620, content transcoding engine 622, content storage 624 and content delivery network 626—interconnected in a manner in which each module may be separately hosted, or a set of such modules may be resident on a single site and/or processor.

In one embodiment, the present system may be built on top of best of breed infrastructure available from existing companies—e.g. database hosting services and cloud computing services. It may be desirable that the communication framework of the present system integrates with media servers, SMS gateways and voice capabilities.

In operation, content transcoding engine 622 may convert content files that are uploaded to content storage 624 in any format, e.g., Microsoft Office documents, pdf files, and various image and video formats, preparing them for direct preview and streaming delivery to computing devices, tablet or smartphones (without any downloads). The present system may also advantageously support the sharing of very large image and video content files such as ultrasounds and MRIs. In addition, the present system may also support parallel and separate communication threads among various subsets of a community, ensuring selective and appropriate access to communications, personal health information, and medical reports. The present system may automatically deposit every communication and medical record into a EHR and EMR repository. Notification engine 608 may support therapeutic reminders, workflows and communications.

### Example of Use and Operation

Having described possible architectures and build-out of the present system, it will now be described the uses and operation of an exemplary system, built in accordance with the principles of the present invention.

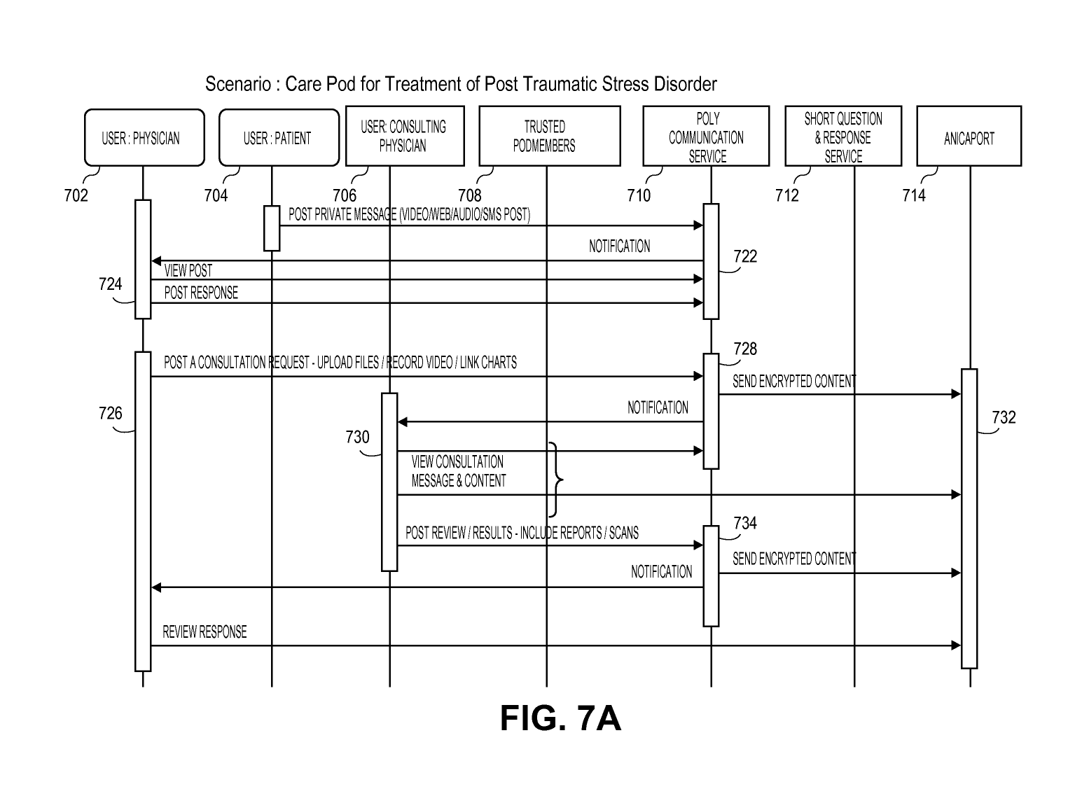

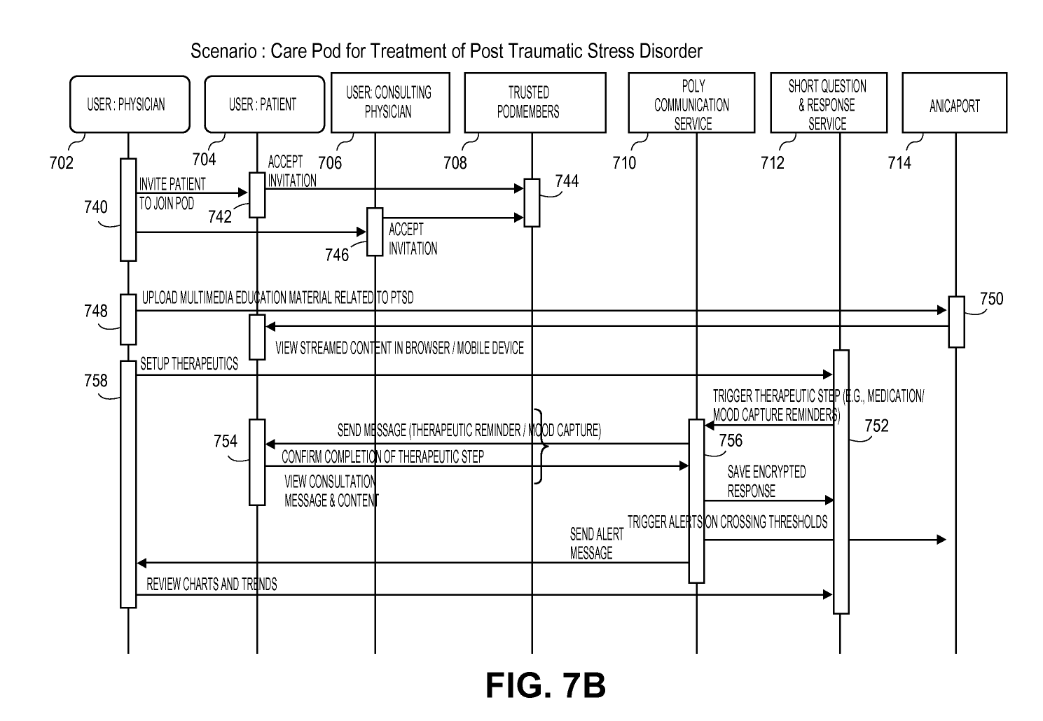

FIGS. 7A and 7B depict the flow of operation of one such embodiment of the present system—i.e. a social pod built and maintained for the management of post-traumatic stress disorder in returning military veterans. It will be appreciated that this embodiment is offered merely for exposition of the present system and does not necessarily limit the scope of invention as claimed below.

In this embodiment, various users may be in communication with other users via and through the present system itself. For example, physicians 702, patient 704, consulting physician 706, other trusted users 708 may be in communication with each other, or various modules of the present system, such as polycommunication service 710, short question and response service 712 and anicaport 714.

In this example, patient 704 may post a private message (at 720, via any known means, e.g. video, web, audio/SMS or the like) meant to be viewed by physician 702. The message may be received by communications service 710 (at 722) and relayed to physician 702 (at 724). Physician 702 may view the post and respond, which is relayed via communication service.

In following-up, physician 702 may post a consultation request at 726 to communication service 710, from which a notification may be sent to consulting physician 706 and a message sent to anicaport 714 at 732. Consulting physician 706 may view the message and content at 730 and then post results of the review back to physician 702 at 734. Anicaport 714 logs all such communications via encrypted content at 732.

In FIG. 7B, physician 702 may invite a new patient 704 and a new consulting physician 706 (at 742 and 746) to join the social pod (as described above) and accept invitations at 744. In addition, physician 702 may decide at 748 to upload certain educational or training materials relating to PTSD to anicaport 750, which then may be viewed by patient 704 as, e.g. streamable content.

Physician 702 may decide to set up a therapeutic regiment for patient 704 at 750. Short question and response service 712 may be employed at 752 to provide reminders and capture any other relevant data (e.g. mood, clinical results, etc) from the patient at 754. If any alert is triggered by the crossing of a threshold (either clinically or via answers or non-compliance noted by the present system), then an alert may be generated and sent to physician at 752, 756 and 750. Lastly, physician 702 may review charts and trends of patient 704 at 752.

### De-Identification

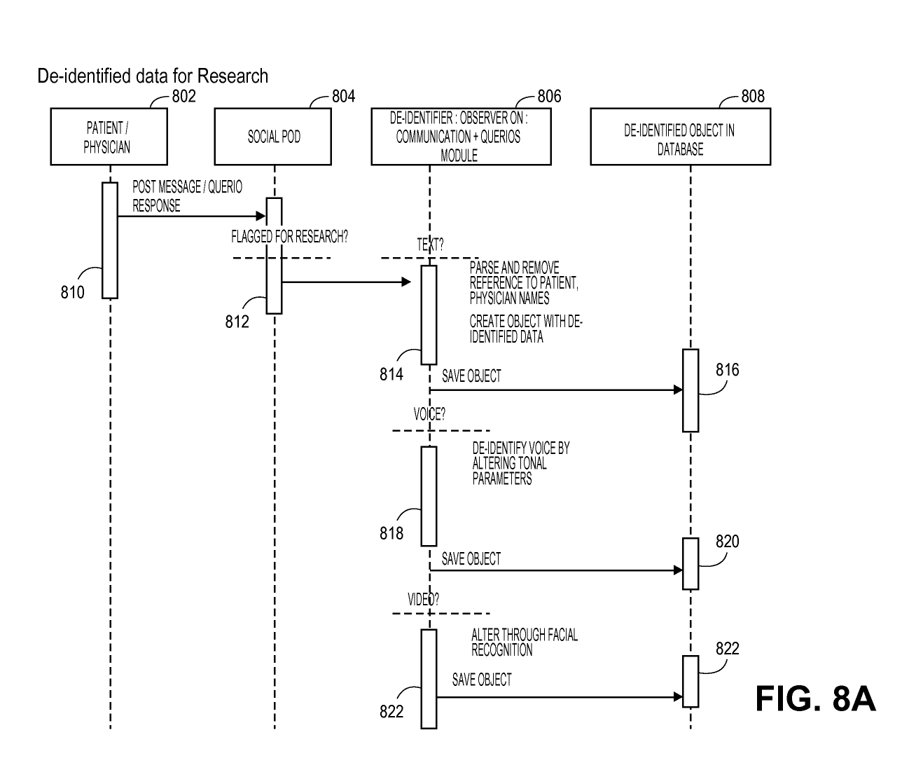

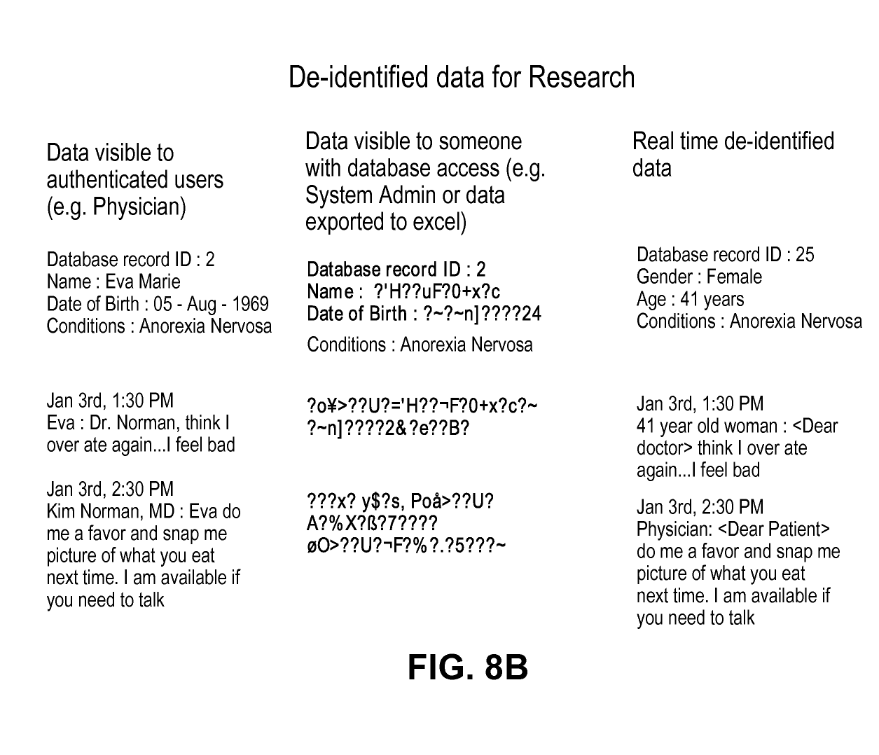

One possible useful feature of a system made in accordance with the principles of the present invention might be the unlinking of patient data from the positive identification of the patient herself. As HIPAA requires that PHI be disseminated in a controlled fashion, FIGS. 8A and 8B depict one embodiment of such a de-identification module.

As noted above, various users of the social pod may be communicating with other users or the system via its interfaces. In this example, physician 802 may be communicating with social pod/system 804. De-identification module 806 may be implemented within the system on top of, or in communication with, query module or communication module or the like. In response, de-identification module 806 may strip out information or data which may be linked to, and help identify, any given patient.

At 810, physician may post a message or a response to the social pod. Such a message, as noted above, may be posted in various forms (e.g. text, voice or video), and it may be desirable that de-identifier module 806 strip out any such identifying data. At 812, such information passed to the social pod 804 may be captured by de-identifier 806. In the case of text at 814, module 806 may parse and remove references to physician and/or patients and create an object without such references, and subsequently be stored at 816.

In the case of voice at 818, module 806 may perform speech recognition to capture information within the message. In addition, module 806 might use voice altering to de-identify the tonal qualities of the individual leaving the message. In the case of video at 822, module 806 may alter pixel data within an image to obscure facial recognition. In addition, module 806 might alter sound and voice data as noted above.

FIG. 8B depicts data and information as may be viewed by either a physician who is authorized to know the identity of the data to whom it is referring—and to others who are not so similarly authorized. The data which is stripped from the data by the present system is depicted in the third column of FIG. 8B.

In one embodiment, the present system may be constructed to capture de-identified data in real-time for research purposes. For example, actual conversations between Physicians/Researchers and Patients (as well as other structured captured data) are typically stored in an encrypted fashion to protect privacy. This however tends to render the data unusable for search and analysis. In these cases, a social pod may be tagged to be “For research”, in which case, the system logs its data in a de-identified form, with the pertinent information but the identifiable elements removed.

### Therapeutics

The present system may also provide a more comprehensive and high engagement support system for better compliance with a therapeutics module. For example, physicians may easily setup a therapeutic action plan and, for each of the components, associate a basket of supporting materials from their online library or record instructions directly through the webcam. The system, will, if setup, send reminders through one or multiple means such as email, voice call or text messages and may require the patient to confirm.

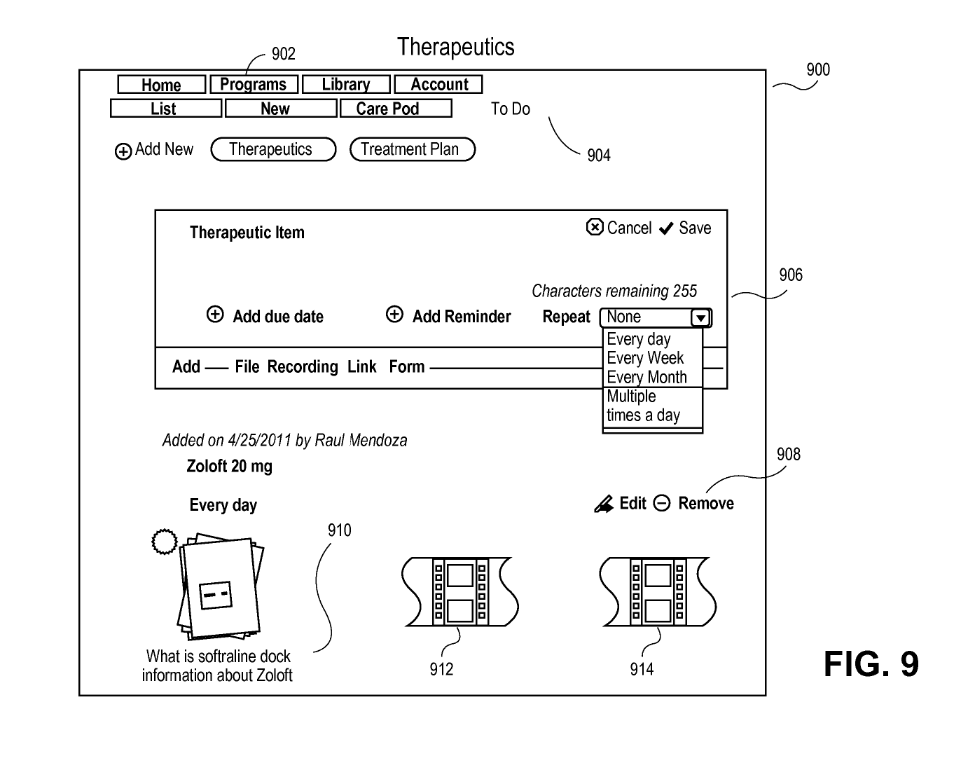

FIG. 9 shows an exemplary screen shot 900 of such a therapeutics interface/module, as may be presented on a web browser or the like. Tabs 902 may be constructed in a user-friendly fashion and, as described above, a To Do tab 904 could be one possible interface to affect a more comprehensive treatment plan for a patient. Possible interfaces might include therapeutic item box 906, where text may be entered by users regarding aspects of the treatment and a set of reminders for treatment may be set in accordance with the treatment plan (e.g. take medications every day, or describe symptoms once a week, take and record vital signs once a month or the like).

In addition, accessible content may be made available through this interface at 908. In this example, the patient has access to a document that describes the medication that she is taking, or the patient may have access to video/audio file 912 that she uploaded to inquire about treatment aspect. Her physician may have responded with a video/audio file 914 in response. Such robust treatment of multimedia content may be delivered as described above.

### Donations and Payments

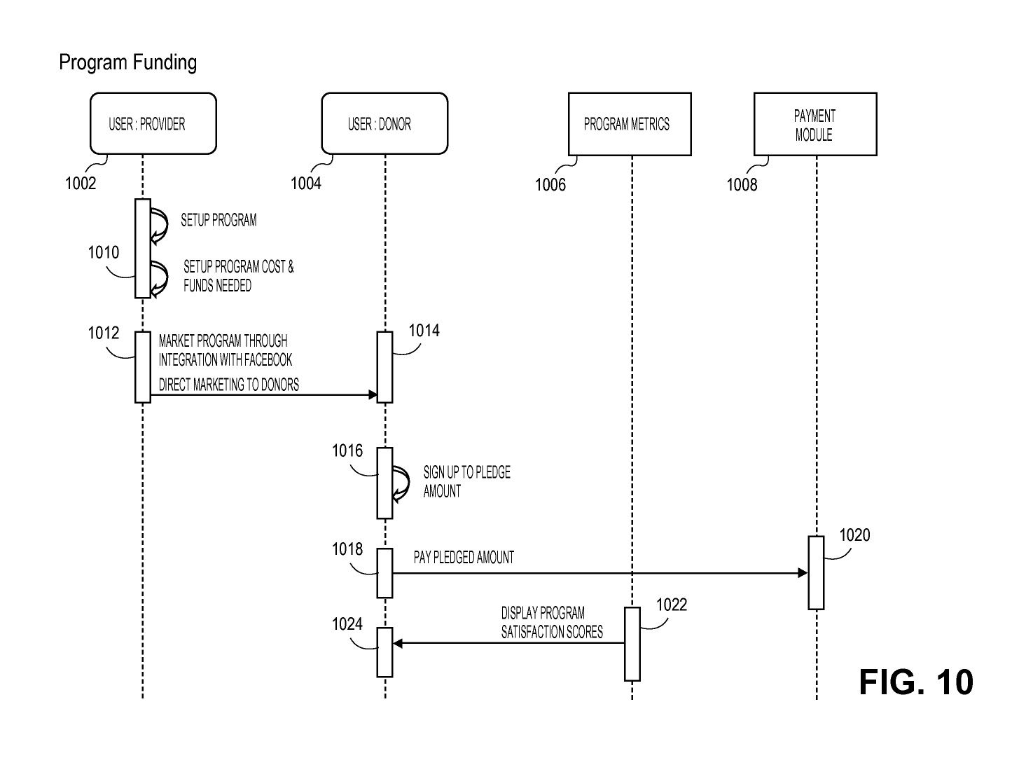

Another aspect of a present system might be a donation and/or payment module that improves the flow of donations and/or payments for programs implemented to address needs of a given social pod. For example, FIG. 10 shows one embodiment of a donation interaction that, in this case, allows providers to raise funds for, e.g., a health outreach program. Donors, in turn, might pledge funds, review outcomes and pay the providers.

Provider 1002 might set up program and outline program cost and funds needed to setup and maintain the program at 1010. Provider 1002 might market such program through any number of channels, e.g. via Facebook or any other social media or outlet at 1012—or market directly to donors. Donors 1004 may receive such marketing at 1014 and pledge some amount at 1016—via the present system. In addition, donors may be made a trusted user and a part of the trusted community, with certain rights and access to materials on the present system. Donor 1004 may make payments at 1018 to payment module 1008 at 1020. To keep the donors informed and engaged, program metrics 1006 may send such metrics—e.g. program satisfaction scores—to donors at 1024, in order for donors to see their donation money at useful work.

### Evidence-Based Analysis of Therapeutic Treatment

The various embodiments of “Pods” (e.g. “CarePods”, “SocialPods” and the like—the terms may be used interchangeably) described herein (and as further depicted in FIGS. 1-10) create a unique place in the cloud that unifies communication and tools needed to coordinate, manage and provide care to a patient. The CarePod has the ability to provide controlled access to various people involved in the care of a patient within and between Doctor's offices to the various parts of a CarePod, such as the communication tools, the charts and records etc. This capability may allow the parties involved to have a single and common place to go to find the information they need about a patient, even if they are physically distant as well organizationally separated—i.e they could be part of two different Healthcare providers in two different parts of the world. The charts and records portion of the CarePod, accommodates the storage of records that exists in an electronic form. This provides the opportunity for healthcare providers to upload files that are in electronic form into the CarePod. Several embodiments of systems and methods are disclosed herein that affect the administering, monitoring, gathering evidence of healthcare interventions and making continuous improvement on intervention based on the evidence, possibly across large populations of patients

As described herein, it may be desirable to provide a system that allows healthcare providers the ability to test administer and do continuous improvements based on evidences for therapeutic intervention protocols. Such therapeutic treatments may have any number of clinical and non-clinical steps, and administered to one or many patients. It may also be desirable to streamline these activities, and to provide interactions and coordination required to administer them. Many embodiments herein affect the tracking of the efficacy of various interventions—whether in evidence-based medicine or translational medicine. In many embodiments, the concepts of the CarePod may provide the coordination, handoffs and the myriad of tools that may increase accuracy and decrease the cost to perform such analysis.

In addition, the framework of the CarePod may support and provide for a Therapeutic Intervention Management (TIM) system. Many present embodiments tend to simplify the process of setting up a therapeutic plan by integrating medical instruments to aid in capturing data, formatting such data and sharing it to relevant groups of doctors, caregivers and researchers. Medical instruments and/or devices are either external (e.g. blood pressure monitor, glucose monitor and the like) or internal (e.g. defibrillators, other electrodes and the like) and these instruments are typically monitoring the medical status of individual patients while they are engaged in some therapeutic treatment and/or protocol. It is desirable that the data captured by such instruments and/or devices be placed into a manageable set of forms and made available to other CarePods—so that data from large patient populations may be aggregated to perform meaningful (and possibly, very timely) clinical analysis.

In many embodiment, systems and methods are provided for the framing the instruments to capture data, administering the instruments, sending reminders, capturing data from the patients or devices connected to the patient and presenting the data. In one embodiment, the information flow from instruments to doctors/researchers may be designed as “touch-less”—i.e., there does not have to be physical handoffs involved between clinical staff, patents, caregivers and the data is available substantially in real-time.

Often in current practice, clinical research & trials and the actual treatment of patients are not tightly integrated. In one embodiment, a tighter integration may be provided by the framework of the CarePod by providing access ubiquity and a unified platform wherein the research and practice occurs in a single continuum—with each providing a flow of information one to the other, resulting in continuous improvement and innovation.

Many embodiments of the present system may be implemented as a cloud-based platform and may provide a networked model where combinations of trusted people, patients, their devices and data around the world may be linked together. Unlike existing enterprise applications such as EMR tools or clinical research databases, that tend to be silos of information and may be architecturally limited in its ability to scale, many present embodiments may allow data from potentially millions of patients to be aggregated using common instruments and common medical terminology within the system.

### One Embodiment

There is increasingly demand for alternatives to hospital based, skilled nursing home-based, and doctors' office-based care services. Growth in the prevalence of alternative care services and facilities, e.g., home-based care services, visiting nurse and visiting aids services, home-based end-of-life care services, home-based maternity and neo-natal care, home-based stroke rehabilitation services, assisted living facilities, outpatient care programs, hospice centers, “step down” care facilities, transitional care facilities, and other home-based and alternative facilities-based services is being driven by many factors, including the aging baby boomer population's preferences for such services, and the critical need to reduce the overall cost of care services.

The expansion of these alternative care services is impeded by the inability of doctors and other care providers to monitor patients' medical conditions while the patients are outside of traditional care settings. Further, the adoption of such services is impeded by the inability of doctors and other care providers to collect, analyze and use data about patients' evolving medical conditions as the basis of better informed, faster, more personalized decisions about their patients' on-going treatment outside of traditional care settings.

Further, doctors and other care providers increasingly need to track the efficacy of therapeutic interventions for cost justification and other purposes. It is especially difficult to fulfill these outcome study requirements when patients are receiving their care outside of traditional care settings.

One embodiment of the present application may enable doctors and other care providers who work within traditional care settings to share information and collaborate with their patients and other care providers who work outside the traditional care settings, including the patients' family members, caseworkers, home-based care providers, etc. Such persons may be physically located anywhere in the world. Any number of people connecting to the Internet through any number of computer networks may collaborate with each other and share information about a patient's care within the patient's CarePod.

The present embodiment may also enable doctors and other care providers to distribute medical expertise, medical advice and care to patients and their other caretakers while the patient is at home or at an alternative care facility using various previously disclosed means.

The present embodiment further tends to support the real-time collection of data about a patient's medical condition gathered from various sources by various means within a patient's CarePod. For example:
(i) Data emitted by medical devices and biosensors that are collected within the patient's CarePod;
(ii) Data queries that are delivered to, and responded to by the patient, his family members or other caretakers within the patient's CarePod;
(iii) Data that are contained in self-initiated reports submitted by the patient, his family members, or other caretakers within the patient's CarePod;
(iv) Data that are collected by mobile device applications and gathered within the patient's CarePod;
(v) Data that are gathered with the patient's CarePod about the patient's genomic, proteinomic, and metabonomic profiles from various sources.

The present embodiment may also enable the rapid analysis of data about a patient's medical condition. In addition, the present application tends to support the appropriately limited dissemination and display of patient information to a patient's various care providers in a HIPAA-compliant manner using previously disclosed means. For example, it may be necessary for a given patient's psychiatrist and OB/GYN doctor to receive clinical information related to the patient's sexual practices, while it is undesirable for the patient's cardiologist or home-care nurse to receive such clinical information.

The present embodiment tends to enable doctors and other care providers to access and use data collected within the patient's CarePod about his medical condition to formulate, change, and personalize the patient's treatment plan. For example, a doctor may:
(i) Change a patient's medication based on the patient's report of deleterious side effects from a pharmacologic agent or a drug combination;
(ii) Order stronger pain medications for an end-of-life cancer patient based on his family member's report that the patient is experiencing increasing levels of pain; and
(iii) Prescribe a dietary prohibition based on metabolic profile data that relate to the patient's changing ability to metabolize particular foods.

The present embodiment may also enable doctors to correlate (i) data that are collected within a patient's CarePod relating to one or more certain aspects of a therapeutic intervention with (ii) data that are also collected with the patient's CarePod relating to the patient's concurrent and/or resultant medical condition. For example, doctors may correlate (i) varied stimulation levels of electrodes that have been surgically implanted in a patient's brain to affect Deep Brain Stimulation (“DBS”) therapy with (ii) data relating to the patient's involuntary movements collected using ankle- or wrist-based motion detectors, and/or data related to the patient's speech disability leveled collected through application of the Guy's Neurological Disability Scale.

The present embodiment may also enable doctors to correlate (i) data collected within a patient's CarePod relating to the function of a medical device with (ii) data that are also collected within the patient's CarePod relating to his concurrent and/or resultant medical condition. For example, doctors may correlate (i) data relating to the magnetic settings of a dynamic compression medical device system for correction of Pectus Carinatum deformity with (ii) data relating to a patient's medical condition collected by performing intermittent manual measurements of the patient's chest circumference, and/or continuously recording the pressure resistance between the patient's chest wall and the compression medical device system, and/or collecting intermittent reports from the patient regarding his relative satisfaction with his physical appearance.

Further, doctors may base clinical decisions on such data correlations, including, for example, adjusting BDS patients' electrode stimulation levels therapeutic intervention based on such data correlations, or changing the magnetic settings of a dynamic compression system for correction of Pectus Carinatum deformity

In addition, since the present embodiment may enable doctors to monitor a patient's medical conditions with whatever degree of frequency and accuracy desired within his CarePod. It enables doctors to monitor the effects of various factors that may affect the efficacy of a given therapeutic intervention. For example, the present embodiment may enable doctors to monitor various factors that may affect a patient's response to DBS treatment, e.g., the sleep vs. wake cycle, posture, etc., in order to devise a better, more personalized therapeutic protocol for the patient.

Further, the present embodiment may enable the conduct of new clinical research trials that are designed to develop a wide variety of new, evidence-based therapeutic interventions, e.g., new, improved DBS-based therapeutic interventions for Parkinson's Disease and other tremor disorders, and faster, more efficient medical device-mediated interventions for chest deformities.

As discussed herein, the present embodiment provides a system that enables healthcare providers to test administer and do continuous improvements based on evidences for Therapeutic intervention protocols having any number of clinical and non-clinical steps, to one or many patients and streamline the activities, interactions and coordination required to administer them. Increasingly the health care community has felt the need for tracking the efficacy of their interventions whether in evidence based medicine or translational medicine. However the coordination, handoffs and the myriad of tools needed to do that effectively makes it cost prohibitive and is fraught with inaccuracies.

The present Therapeutic Intervention Management system provides a solution to this problem in a single platform. It tends to simplify the whole process of setting up a Therapeutic plan, framing the instruments to capture data, administering the instruments, sending reminders, capturing data from the patients or devices connected to the patient and presenting the data. The whole process may be completely touch-less, meaning there are no physical handoffs involved between clinical staff, patents, caregivers and all the data is available in real-time. Current tools and processes separate Clinical research & trials and actual practice. The present embodiment tends to remove this barrier and transform the current approaches through its access ubiquity and unified platform wherein the research and practice occurs in a single continuum, each feeding the other, resulting in continuous improvement and innovation. The present embodiment may be cloud based and the implementation of the CarePod construct allows it to be a networked model where any combination of people, patients, their devices and data around the world can be linked together. Current existing enterprise applications such as EMR tools or clinical research databases tend to be silos of information and architecturally limited in its ability to scale. The present embodiment however allows data from millions of patients to be aggregated using common instruments and common medical terminology within the system.

### One Exemplary Embodiment

It will now be discussed one possible exemplary embodiment made in accordance with the principles of the present application. It should be appreciated that the present example is provided merely for its expository nature—and is not meant to limit the scope of the claimed invention herein.

In this example, it will be considered a simple intervention and the how that intervention is administered and managed using current processes and tools. Assume a hospital develops a “Post-Operative Discharge” intervention protocol that has the following steps spread over 6 weeks:
(1) Provide the patient and their family with a checklist of the steps to be followed.
(2) Provide the patient and their family with education material about the post-operative care.
(3) Medication management for the first 2 weeks.
(4) Track of progress that requires them to capture in a form—e.g., their mood or blood pressure and/or blood glucose.
(5) Have a check-in appointment after 2 weeks.
(6) Continue medication management for another 2 weeks along with tracking data.
(7) Have another check-in appointment after 4 weeks.
(8) Have a final appointment at 6 weeks.

In current and typical practice, patients are hand-delivered paper checklists which have the risk of getting lost. In addition, DVDs may be burned for videos if applicable and handed to patients. Medication management and compliance may be placed in the hands of the patient which risks a lack of compliance—one of the key reasons for re-admissions. Side effects may not be tracked in real time. Timely escalation to physicians for adverse effects may or may not happen.

In addition, typical tracking of progress requires patients to capture in a form which may incomplete. Data capture may not be consistent because it is burdensome and patients may forget. This captured data is typically available to the physician only during the scheduled follow-up office visits. Check-in visits usually require a physical trip to the Hospital or a visit from the hospital, which tends to be time consuming and expensive. Paper reports have to collected, collated, filed and possibly manually entered into a database by the hospital staff

By contrast, the above protocol may be streamlined in one embodiment of the present application. If this streamlined protocol is made available to new and existing CarePods, then a CarePod—created for a patient—may begin to automatically seed the Treatment Protocol. Patient educational material may also be pre-seeded into the Treatment plan. These materials may be made available to the patient from anywhere location where the patient can access his/her CarePod.

For medication management, the patient and their caregivers may receive automated reminders and compliance may be captured from the patient directly using their computers or mobile devices or medical devices (over a wireless or wired link) that use the messaging framework of CarePod. Data may be automatically stored in the database and data is charted in the dashboard in real time. Automatic alerts may be sent to physicians if defined thresholds are crossed.

Check-in appointments may be performed by using an audio-visual application that is implemented in the CarePod—unless a physical checkup is required by the physician. The patient's charts may be made directly available to the physician requiring no handoff.

### Embodiment of Therapeutic Intervention Management (TIM) System

In one embodiment, the present system allows for the integration of data from medical instruments and/or devices into the TIM system and may be used by CarePods for both the individual treatment of the patient—as well as for the aggregation of such data across numerous patients. The TIM system may comprise a number of different modules—designed to create tools for the designer to manage the TIM system. Such modules will now be discussed herein and may comprise: (1) Create Instrument Module—for the creation of data structures and forms for the capture of data from various medical instruments and/or devices; (2) Create Treatment Plan Module—for the creation of therapeutic treatment protocols; (3) Send Reminder Module—for the creation of a reminder system for patients who are involved in a treatment protocol; and (4) Capture Data Module—for the effective capture of medical data from the patient and any medical device involved in the treatment protocol.

### Create Instrument Module

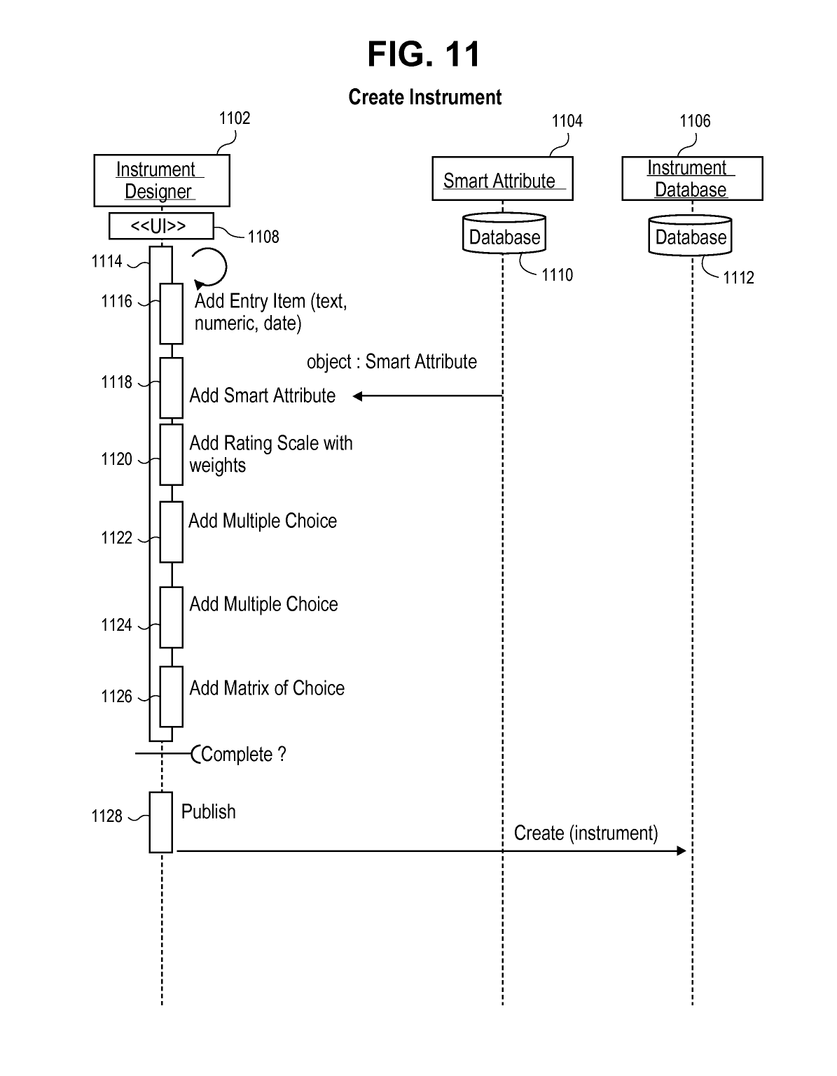

FIG. 11 depicts a module for the creation and/or integration of the data from such instruments, possibly by the creation of electronic forms and/or templates that capture the metadata of such instruments and/or devices. Instrument designer module 1102 (e.g., via a UI 1108) allows the healthcare professionals to create templates for instruments—and their associated medical data that they generate—to be populated electronically and stored in online library in the patient's CarePod. The instrument designer allows the author to select from a rich set of data capture attributes that can be included in the instruments, possibly with built-in data validations.

Process 1114 may be used by the designer to create such forms and/or templates—by adding one or more fields and/or data structures, as desired. It will be appreciated that process 1114, as shown, is merely given as one example of such a process—and that other fields and/or data structures may be appended to the process, as appropriate and/or as desired to adequately capture the medical data. Examples of such field additions may include: Add Entry Item 1116 (e.g. text, numeric data, date or the like), Add Rating Scale with weights 1120 (e.g., for the capture of possibly subjective data from the patient); Add Multiple Choice fields 1122 and 1124 (e.g. for whatever purpose desired by the designer to capture relevant clinical data); Add Matrix of Choice 1126 (e.g. for another manner of capturing relevant data).

In addition to these fields, designers may desire to Add Smart Attribute 1118. Such a Smart Attribute may be available from Smart Attribute Module 1104 and an associated database 1110. Smart Attributes allow the designer to construct Instruments, Forms, Tags, etc. for use within CarePods that may standardize data attributes and limit them to a potentially finite and common list. These Smart Attributes may affect the ability to conduct Big Data analysis (as described below). For example, it may be possible to have a Smart Attribute called Pertinent History, and that attribute will have a list of value of the Category: Disease and Conditions. This may be synchronized with the Unified Medical Language System from NIH. Thus, if one of the CarePod designers uses the Pertinent History smart attribute while customizing a Patient CarePod, or Creating a Patient Intake form, or a Clinical Trial Case Report form, or a Research project, then values, that may be entered, will conform to the standardized language used worldwide.

### Create Treatment Plan Module

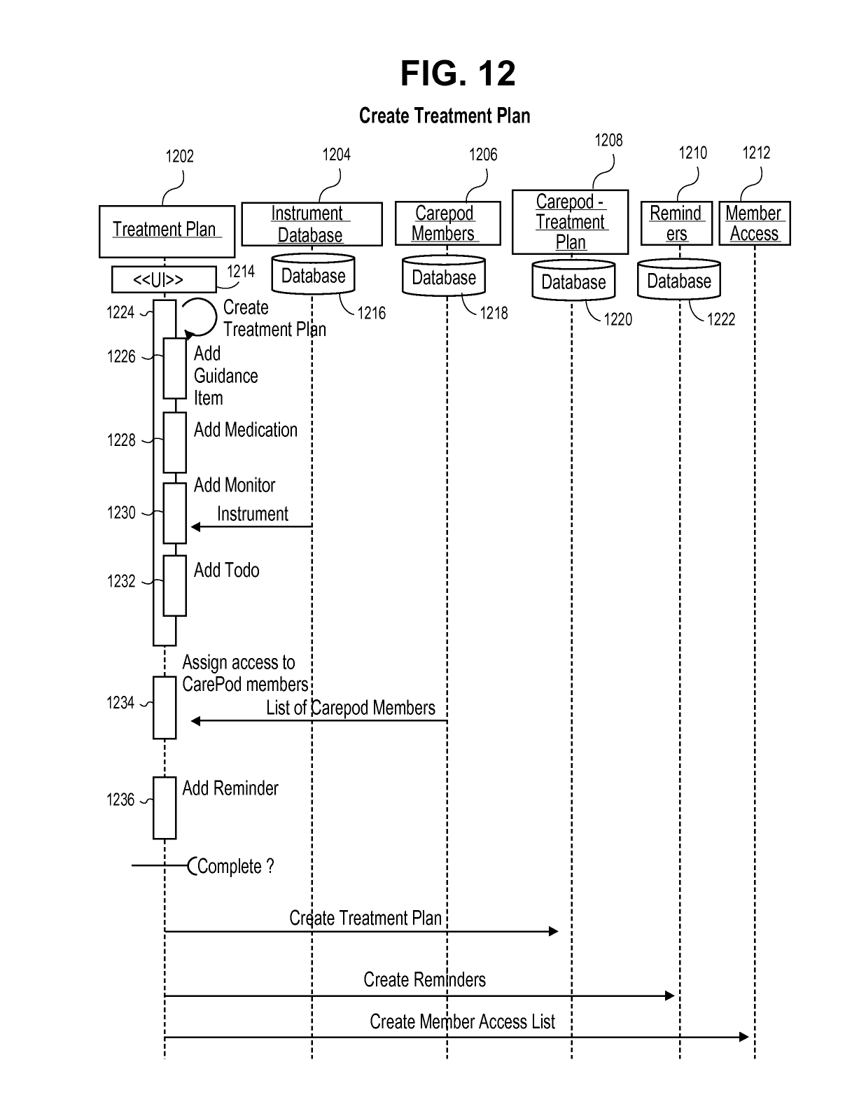

FIG. 12 depicts one embodiment of a Create Treatment Plan Module that might allow a caregiver the ability to create a treatment plan (therapeutic or otherwise) for either a single patient in a CarePod, or a Plan template to be used by other caregivers for other patients in other CarePods. Treatment plans tend to address a particular condition of a patient that may respond to therapy. It will be appreciated that the notion of treatment plan and condition for treatment may be considered broadly. The condition may be a disease condition, a congenital condition, a mental condition or any other possible condition of a patient for which treatment plans may have efficacy.

Caregiver may use Treatment Plan module 1202 (e.g. via a UI 1214)—and may access any number of possible other modules and/or databases to aid the creation of such a Plan. Process 1224, as depicted, may employ one or more modules to create such a Plan. For example, the creator may Add Guidance data item 1226, Add Medication data item 1228, Add Monitor data item 1230 (e.g., data and/or metadata about blood pressure monitor or glucose monitor, or other Instrument), Add Todo data item 1232 (for providing a checklist or other guidance). These data items may be optionally added to the Plan (i.e. treatment plan template for the patient being treated for a condition). A guidance data item may be an informational data item for the patient regarding the condition and treatment thereof. The guidance data item may be any form of media possible or desired to disseminate the information.

As mentioned, other modules may be employed to aid in the Plan's construction. For example, the creator may access Instrument Database module 1204 and its associated database 1216 to access metadata forms (e.g. as may have been created using Create Instrument module, discussed above. In one embodiment, Treatment Plan module may request forms and/or templates that aid to capture, collect and/or collate data from any instrument, device or biosensor that may have relevant data to collect regarding the treatment (and the efficacy thereof) of the patient.

To implement a Plan, the creator and/or caregiver may consult a CarePod Members module 1206 and its associated database 1218—to provide a list of CarePod Members for which are authorized to interface with the CarePod for a particular patient and his/her Plan. In one embodiment, the system may reduce the list of CarePod Members to only those who are both CarePod Members and are relevant to the treatment plan itself. In addition, the creator and/or caregiver may employ Add Reminder module 1236—to provide a scheduled reminder to the patient and/or caregiver for follow-up on treatment and status.

If the Plan is complete, then the creator and/or caregiver may Create Treatment Plan and release it to CarePod Treatment Plan module 1208 and its associated database 1220. In addition, the creator and/or caregiver may Create Reminders and release to Reminders module 1210 and its associated database 1222 a set of reminders to patients, caregivers and/or relevant CarePod Members of treatment events that are incorporated into the treatment plan. Lastly, the creator and/or caregiver may Create Member Access List—to the Member Access module 1212—to ensure secure and authenticated Plan communications are accurately disseminated to the correct entities.

### Send Reminders Module

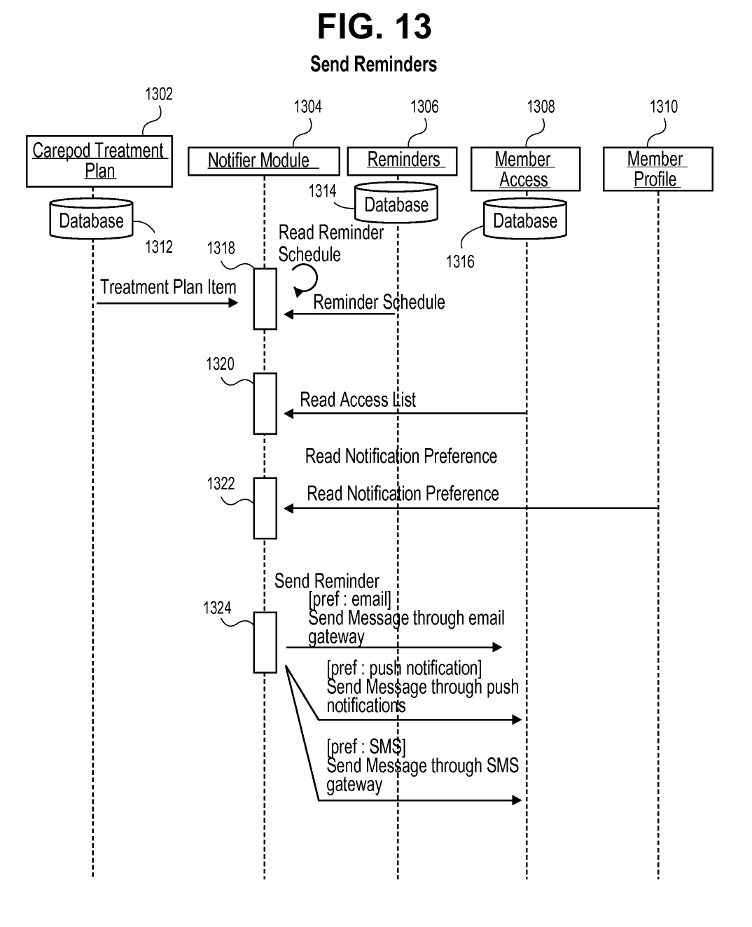

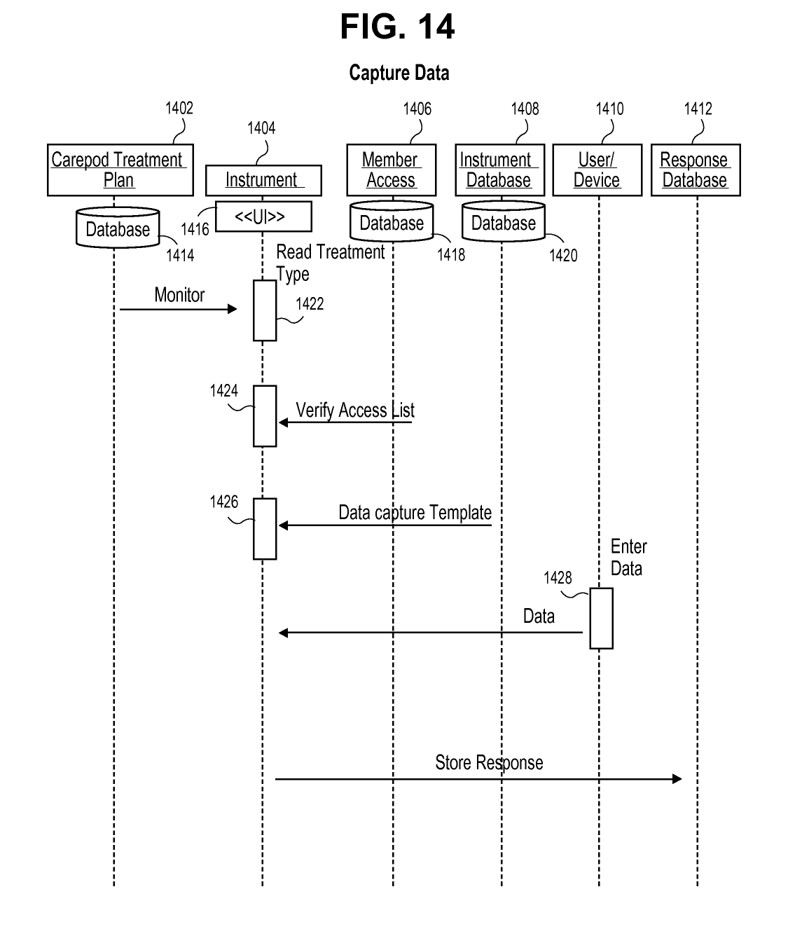

FIG. 13 depicts one embodiment of a Send Reminders Module. This module takes the items that have a reminder and send notifications based on the methods specified—e.g through email, push notifications in the mobile devices or SMS. It also presents the data capture instruments to users and stores the information in the database.

In this embodiment, CarePod Treatment Plan module 1302 and/or its associated database 1312 may send a Treatment Plan Item to Notifier Module 1304 at 1318. Such Treatment Plan Item may comprise data and/or metadata regarding the patient's treatment plan. Such data and/or metadata may be the entire treatment plan itself or may be a subset of treatment plan data and/or metadata that is relevant to treatment events.

Notifier Module 1304 may read a Reminder Schedule—which may be received from Reminders module 1306 and its associated database 1314. In addition, Notifier Module may read the Access List (at 1320) from Member Access module 1308 and its associated database 1316. The Access List may comprise members who are in the patient's CarePod and are to be reminded of treatment events within the patient's treatment plan. Further, Notifier Module 1304 may read Notification Preferences from Member Profile module 1310—which may list the preferred manner in which a member may desire to receive one or means of reminder communications. It will be appreciated that in other embodiments Member profiles may be included in the Member Access List.

From this set of metadata, Notifier Module 1304 may then Sent Reminders (e.g., at 1324) to Members regarding certain treatment events with a patient's treatment plan. As depicted, members may receive scheduled reminders of treatment via email, push notification, SMS or any other suitable means of communication.

### Capture Data Module

Another possible module in an embodiment of the present application might be Capture Data Module. In this module, CarePod Treatment Plan 1402 and its associated database 1414 may monitor medical data from an instrument and/or device associated with the treatment plan. The forms and or data structures for the storage and management of data and/or metadata from such an instrument may have been created by Instrument module 1404 (via a UI 1416).

In one embodiment, CarePod Treatment Plan module may send a monitor request to such Instrument module. In response, the Instrument module may read the Treatment type and acquire an Access List of Members from Member Access module 1406 and its associated database 1418. In addition, the Instrument module may acquire the forms and/or templates to capture relevant medical and/or clinical data from Instrument Database module 1408 and its associated database 1420.

Once this data and/or metadata has been received, Instrument module 1404 may acquire actual medical and/or clinical data from User/Device 1410. Instrument module may then store the response to the Treatment Plan into a Response Database 1412.

This data may be used in a two-fold manner subsequently. First, it is possible to tell how well an individual patient is responding to his/her treatment plan. From that information, caregivers may be able to alter the Treatment Plan during its course. Secondly, this data may be aggregated together over a large patient population and be used to discern the overall efficacy of the Treatment Plan—and possibly use it for predictive measures for success of a treatment plan for a given patient.

### Big Data Analytics

As discussed above, therapeutic interventions designed and administered through the systems and methods of the present application described herein may be aggregated and scaled to hundreds of thousands patients from the healthcare providers towards capturing and collating information. This creates a significantly large database of data also referred to as “Big Data”. The tagging of data items using standard medical terminology in the Instrument Designer module makes it conducive to Big Data Analytics, which is currently a challenge of fragmented data capture and data interpretation methods. Data collected in this fashion may make it possible to significantly accelerate the ability to gather information about the efficacy of an intervention, leading to quicker correction and refinement of intervention protocols.

A detailed description of one or more embodiments of the invention, read along with accompanying figures, that illustrate the principles of the invention has now been given. It is to be appreciated that the invention is described in connection with such embodiments, but the invention is not limited to any embodiment. The scope of the invention is limited only by the claims and the invention encompasses numerous alternatives, modifications and equivalents. Numerous specific details have been set forth in this description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

1. A system for creating treatment plans for patients, wherein said patients and their caregivers are members of a trusted community of a CarePod, the system comprising:
a treatment plan module, said treatment plan module capable of creating a plan for treating a patient for a particular condition;
an instrument database module, said instrument database capable of receiving request by said treatment plan module and returning a template for collating data from one of a group, said group comprising: a medical instrument, a medical device and a biosensor;
a CarePod members module, said CarePod members module capable of receiving request from said treatment plan module and returning a list of CarePod members who are trusted community entities for said patient; and
a reminders module, said reminders module capable of creating and storing reminders, said reminders capable of being sent automatically to said patients and said caregivers regarding relevant treatment events in said treatment plan.

2. The system as recited in claim 1 wherein said treatment plan module further comprises at one of a group, said group comprising: an Add Guidance Item module, an Add Medication module, an Add Monitor module and an Add Todo module.

3. The system as recited in claim 2 wherein said treatment plan module further comprises a CarePod Treatment Plan module, said CarePod Treatment Plan module capable of storing a completed treatment plan for said patient in a database, said database capable of being accessed by entities in a Members Access List.

4. A system for sending reminders of treatment events in a treatment plan to patients and other members in a Member Access List, said patient and other members being members of a trusted community in a patient's CarePod, the system comprising:
a notifier module, said notifier module capable of inputting data regarding a patient's treatment plan and sending reminders of treatment events within said patient's treatment plan;
a CarePod Treatment Plan module, said CarePod Treatment Plan module capable of sending treatment plan data to said notifier module, said treatment plan data comprising data regarding said patient's treatment;
a reminders module, said reminders module capable of sending treatment reminders schedule of said treatment events to said notifier module;
a Member Access module, said Member Access module capable of sending a list of members of patient's CarePod who are to be reminded of treatment events to said notifier module; and
a Member Profile module, said Member Profile module capable of sending notification preferences of said list of members who are to be reminded of treatment events; and
wherein said notifier module, capable of sending reminders to said list of members reminders of treatment events, said reminders sent according to the notification preference of each such member in said list of members.

5. A system for capturing data from treatment plans for patients, said patients having an associated CarePod and said treatment plan being associated with said CarePod, the system comprising:
an instrument module, said instrument module capable of inputting data regarding a treatment plan for patients, data regarding medical instrument templates, data from medical instruments, said medical instrument templates being associated with said medical instruments;
a CarePod Treatment Plan module, said CarePod treatment Plan module capable of sending data regarding medical instruments associated with said treatment plan to said instrument module;
an instrument database module, said instrument database module capable of sending templates regarding data capture from an instrument; and
a response database, said response database capable of storing data received by said instrument module from an instrument.

6. The system as recited in claim 5 wherein said medical instrument is one of a group, said group comprising: a medical instrument, a medical device and a biosensor.

7. The system as recited in claim 6 wherein said instrument module is capable of receiving data from a medical instrument, said medical instrument capturing data from said patient involved in said treatment plan.

8. The system as recited in claim 7 wherein said response database is capable of storing patient data from a plurality of patients involved in said treatment plan.

9. A method for creating a treatment plan for a patient, said patient having an associated CarePod and associated trusted caregivers for said CarePod, the steps of said method comprising:
creating a treatment plan template for a patient having a condition;
assigning access to said treatment plan to a set of said CarePod members of said patient's CarePod;
creating a set of reminders for said treatment plan, said reminders associated with a set of treatment event.

10. The method as recited in claim 9 wherein the step of creating a treatment plan template further comprises:
adding a guidance data item.

11. The method as recited in claim 9 wherein the step of creating a treatment plan template further comprises:
adding a medication data item.

12. The method as recited in claim 9 wherein the step of creating a treatment plan template further comprises:
adding a monitor data item.

13. The method as recited in claim 9 wherein the step of creating a treatment plan template further comprises:
adding todo data item.

14. A method for capturing the data created during a treatment plan, said treatment plan treating a patient for a condition and wherein said patient has an associated CarePod, the step of said method comprising:
receiving treatment plan information;
receiving template information regarding instrument associated with said treatment plan;
verifying member access list for patient's treatment, said members being associated with patient's CarePod;
receiving data from said instruments, said instruments capturing data from said patients; and
storing treatment data from said instruments in a response database.

15. The method as recited in claim 14 wherein said treatment data comprises data aggregated from a plurality of patients being treated for said condition.

16. The method as recited in claim 15 wherein said aggregated data from a plurality of patients is input into an analytic process to assess the efficacy of said treatment plan.
